(19) United States
(12) Patent Application Publication
(10) Pub. No.: US 2007/0071125 A1
(43) Pub. Date: Mar. 29, 2007

(54) METHOD AND APPARATUS FOR IFDMA TRANSMISSION

(75) Inventors: Jun Tan, Dearborn Heights, MI (US); Amitava Ghosh, Buffalo Grove, IL (US); Fan Wang, Vernon Hills, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/532,545

(22) Filed: Sep. 18, 2006

Related U.S. Application Data
(60) Provisional application No. 60/721,924, filed on Sep. 29, 2005.

(51) Int. Cl. H04K 1/10

(52) U.S. Cl. 375/260

(57) ABSTRACT

Various embodiments are described to provide for the transmission of data in an improved manner. Data transmission is improved by including in a transmitter a null generator to embed frequency domain nulls into a data symbol sequence to produce a null-embedded data symbol sequence. A symbol inserter inserts a control symbol sequence into the frequency domain nulls of the null-embedded data symbol sequence to produce a combined symbol sequence. A modulator then encodes the combined symbol sequence using IFDMA/DFT-S-OFDM. This approach allows the assignment of a single IFDMA/DFT-S-OFDM code to each user for data and control (pilot, e.g.) signaling, simplifying code management. Frequency hopping techniques may also be employed to lower the pilot overhead.

### REFERENCE(S) TO RELATED APPLICATION(S)

The present application claims priority from provisional application, Ser. No. 60/721924, entitled “METHOD AND APPARATUS FOR IFDMA/DFT-S-OFDM TRANSMISSION,” filed Sep. 29, 2005, which is commonly owned and incorporated herein by reference in its entirety.

This application is related to a co-pending application, Ser. No. 11/054,290, entitled “METHOD AND APPARATUS FOR TRANSMISSION AND RECEPTION OF DATA,” filed Feb. 9, 2005, which is assigned to the assignee of the present application and is hereby incorporated by reference.

### FIELD OF THE INVENTION

The present invention relates generally to data communications, and in particular, to a method and apparatus for IFDMA (interleaved frequency division multiple access) and DFT-S-OFDM (discrete fourier transform spread orthogonal frequency division multiplexing) transmission.

### BACKGROUND OF THE INVENTION

Interleaved frequency division multiple access (IFDMA) and discrete fourier transform spread orthogonal frequency division multiplexing (DFT-S-OFDM) are single carrier modulation and multi-access scheme with some desirable characteristics of both orthogonal frequency division multiple access (OFDMA) and single carrier modulation. One advantage of IFDMA/DFT-S-OFDM is its low peak-to-average power ratio (PAPR), which is desirable for uplink E-UTRA (Evolved UMTS Terrestrial Radio Access) transmission. IFDMA/DFT-S-OFDM can also support a wide range of data rates and provide frequency diversity for low data rate users.

FIG. 1 is a block diagram depiction of IFDMA transmitter components. As depicted in block diagram 100, a number of information data symbols are grouped into a block and the block is repeated L times (110) prior to modulation (120), the addition of a cyclic prefix (130), and filtering (140) (typically with a root-raised cosine filter). IFDMA modulation can be operated in a distributed FDMA (frequency division multiple access) mode if the repetition factor L is greater than 1 or in a localized mode with L equal to 1 and using pulse shaping digital filters tuned according to user bandwidth. IFDMA is also equivalent to distributed DFT-S-OFDM, where interlaced subcarriers are allocated to users. Optional DS spreading (150) can be used with IFDMA to further provide frequency diversity. In addition, a receiver based on Frequency Domain Equalization (FDE) would be used with this system.

Two types of pilot configurations, time-division multiplexing (TDM) and frequency-division multiplexing (FDM), are commonly used for IFDMA pilot allocation. However, since a TDM pilot is not always present, channel estimation performance suffers some degradation when a user's speed is high. In contrast, an FDM pilot is present all the time, with the data and pilot using different IFDMA codes (or sub-channels) to keep them orthogonal. An FDM pilot configuration can track the channel change at high vehicle speed. However, IFDMA code assignment is needed to manage the different data and pilot sub-channels.

For example, FIG. 2 depicts an IFDMA code structure. As code tree 200 illustrates, IFDMA manages codes (or sub-channels) using a tree-like structure. A node in the tree represents a set of frequencies orthogonal with the sets corresponding to nodes on the same or higher tree levels. In the example FIG. 2 depicts, a user's data channel uses code (128, 2, 1), meaning that there are 128 symbols per block, a repetition factor of 2 and a frequency shift of 1; while the user's pilot channel uses code (32, 8, 0) to reach a 25% pilot/data ratio. However, this type of pilot allocation makes the other unused codes (32, 8, 4), (32, 8, 2), and (32, 8, 6) costly to be allocated for data symbols. For example, allocating the unused codes (to provide high-rate data, e.g.) can increase the peak-to-average power ratio.

Thus, it would be desirable to have an apparatus and method that enabled an IFDMA pilot configuration, which did not exhibit some of these drawbacks.

### BRIEF DESCRIPTION OF THE DRAWINGS

FIG. 1 is a block diagram depiction of IFDMA transmitter components in accordance with the prior art.

FIG. 2 is a code tree depiction of an IFDMA code structure in accordance with the prior art.

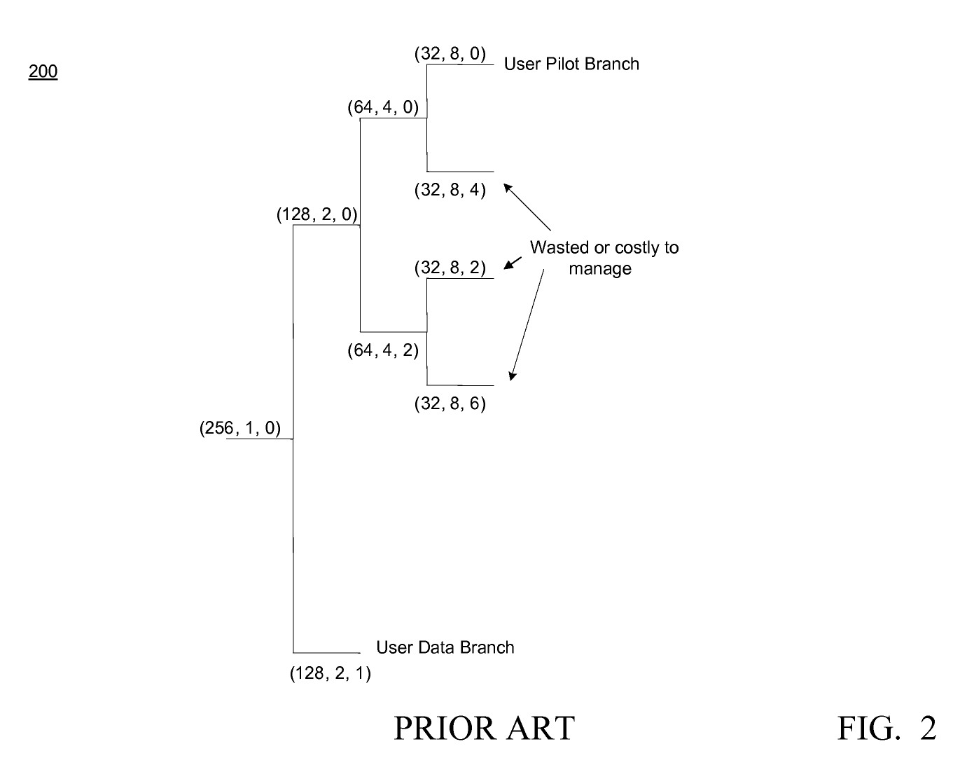

FIG. 3 is a block diagram depiction of transmitter components in accordance with multiple embodiments of the present invention.

FIG. 4 is a block diagram depiction of transmitter components in accordance with certain embodiments of the present invention.

FIG. 5 is a code tree depiction of an IFDMA code structure in accordance with certain embodiments of the present invention.

FIG. 6 is a frequency domain illustration of an example of multi-user pilot insertion.

FIG. 7 is a block diagram depiction of null generator components in accordance with certain embodiments of the present invention.

FIG. 8 is a block diagram illustration of an example of frequency hopping from one block to the next.

FIG. 9 is a table conveying some numerical characteristics of various embodiments of the present invention.

FIG. 10 is a logic flow diagram illustrating functionality performed in transmitting data in accordance with multiple embodiments of the present invention.

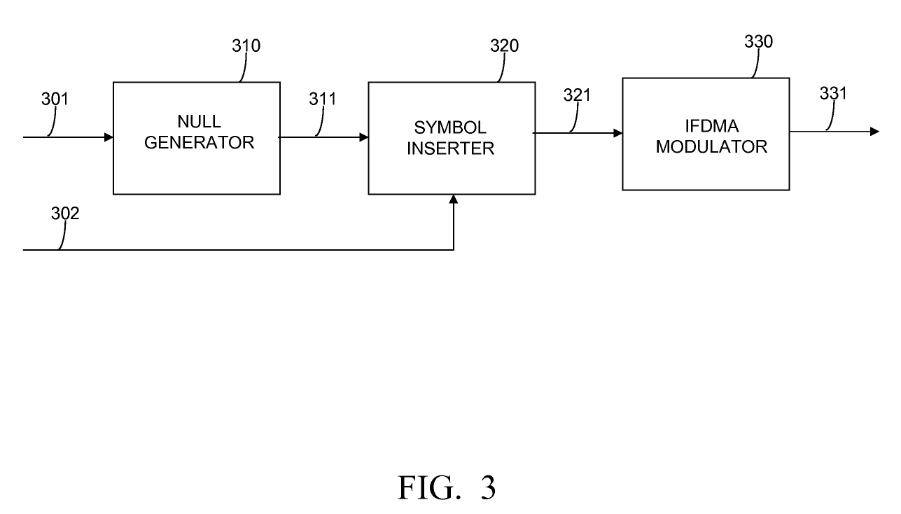

Specific embodiments of the present invention are disclosed below with reference to FIGS. 3-10. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to provide for the transmission of data in an improved manner. Data transmission is improved by including in a transmitter a null generator to embed frequency domain nulls into a data symbol sequence to produce a null-embedded data symbol sequence. A symbol inserter inserts a control symbol sequence into the frequency domain nulls of the null-embedded data symbol sequence to produce a combined symbol sequence. A modulator then encodes the combined symbol sequence using IFDMA/DFT-S-OFDM. This approach allows the assignment of a single IFDMA/DFT-S-OFDM code to each user for data and control (pilot, e.g.) signaling, simplifying IFDMA code management. Frequency hopping techniques may also be employed to lower the pilot overhead.

Operation of embodiments in accordance with the present invention occurs substantially as follows with reference to FIGS. 3-10. FIG. 3 is a block diagram depiction of transmitter components in accordance with multiple embodiments of the present invention. FIG. 3 depicts null generator 310, symbol inserter 320, and IFDMA modulator 330. Null generator 310 embeds frequency domain nulls into data symbol sequence 301 to produce null-embedded data symbol sequence 311. Thus, sequence 311 exhibits nulls in the frequency domain at particular frequencies that sequence 301 does not.

Symbol inserter 320 then inserts control symbol sequence 302 into the frequency domain nulls of null-embedded data symbol sequence 311 to produce combined symbol sequence 321. In many embodiments, the control symbol sequence comprises pilot symbols, although it need not comprise pilots. Also, depending on the embodiment, the control symbol sequence may be block repeated in order for the resulting symbol sequence to exhibit control signals in the frequency domain that correspond to the nulls of the null-embedded data symbol sequence. In such embodiments, the control signals will replace (or be inserted into) the nulls when the sequences are added.

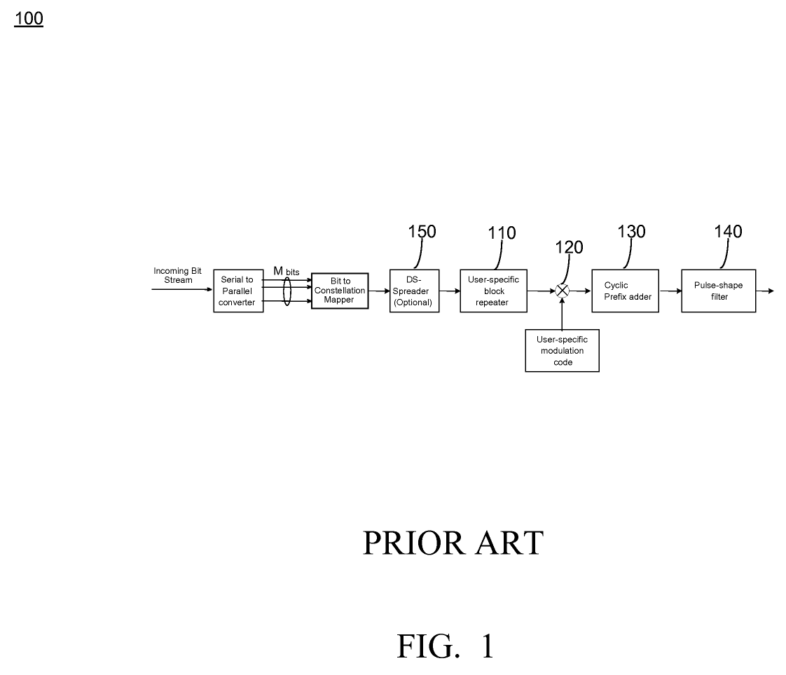

IFDMA modulator 330, then, uses (i.e., operates in accordance with) an IFDMA code to encode (i.e., modulate) combined symbol sequence 321 to produce encoded symbol sequence 331. In many embodiments, but not all, the components of FIG. 1 may reside in user equipment (UE). Examples of various forms of user equipment include, but are not limited to, mobile stations (MSs), access terminals (ATs), terminal equipment, mobile nodes (MNs), cell phones, gaming devices, personal computers, and personal digital assistants (PDAs). Also, in some of these embodiments, each UE will be assigned a unique IFDMA code for signaling. In such embodiments, then, the IFDMA modulator encodes the combined symbol sequence using the UE's assigned IFDMA code.

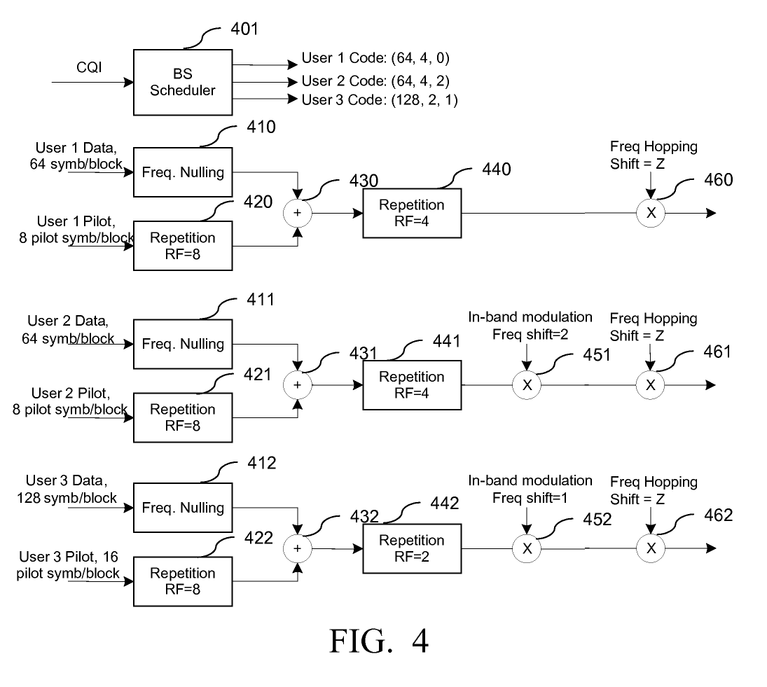

FIG. 4 is a block diagram depiction of transmitter components in accordance with certain embodiments of the present invention. FIG. 4 illustrates an example of three UEs with variable data rates. For this example, user 3 has a data rate twice that of users 1 and 2. Each UE is assigned an IFDMA code by scheduler 401, as depicted in these embodiments. By embedding its pilot symbols into its data stream, each UE may use a single IFDMA code for its data and pilot signaling. This enables the three UEs to be allocated all of the possible sub-channels.

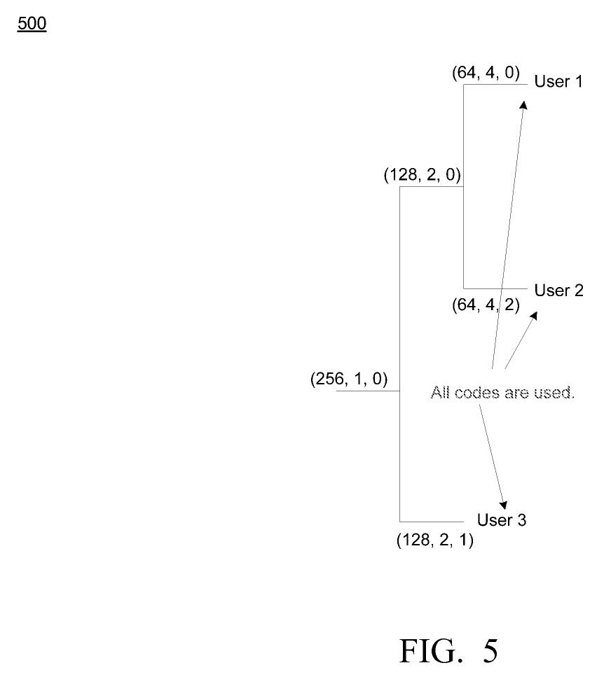

FIG. 5 is a code tree depiction of the IFDMA code structure used in the example of FIG. 4. As shown, the three UEs occupy three IFDMA sub-channels (64, 4, 0), (64, 4, 2), and (128, 2, 1). Clearly, the coding structure of code tree 500 is more desirable than that of prior art code tree 200. With code tree 500, each UE has one IFDMA code for its data and control channel, and the IFDMA code management is easier than in the case of code tree 200. Moreover, all IFDMA codes are assigned in code tree 500 to achieve maximum system throughput.

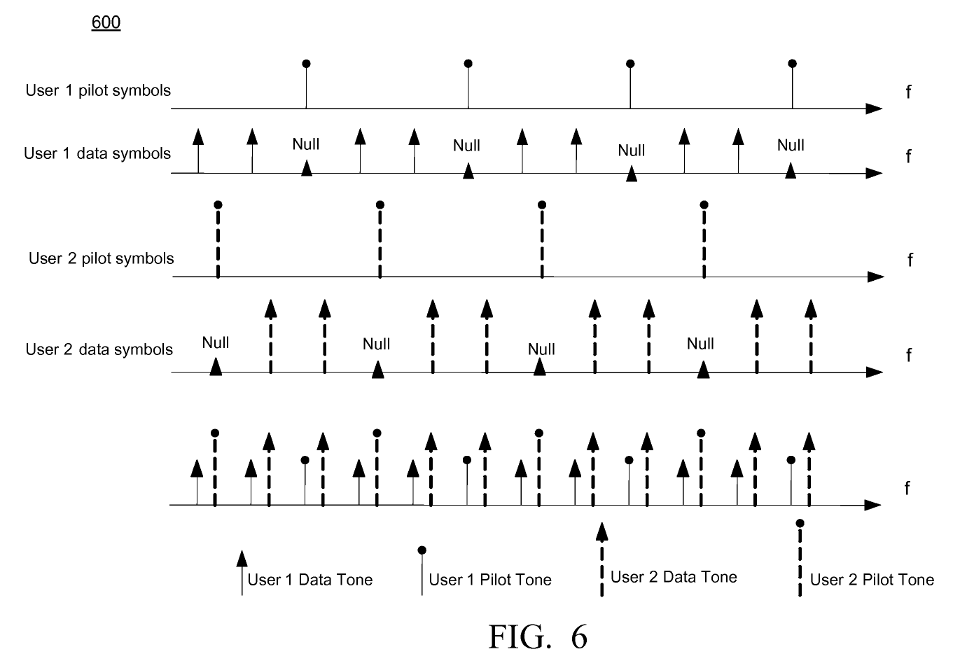

In the example of FIG. 4, frequency nulling is employed to embed pilot symbols into a single IFDMA sub-channel. FIG. 6 is a frequency domain illustration of such multi-user pilot insertion for the case of two users. In illustration 600, user 1 and user 2 use different IFDMA sub-channels to ensure their orthogonality. Within the sub-channel of user 1, a frequency nulling technique is used to create nulls in the frequency domain. In other words, the signal of user 1 has zero values embedded at certain sub-carriers. Pilot symbols are then inserted at these frequency nulls, thereby providing orthogonality between the user 1 data and pilot signals. The same pilot insertion approach can be employed by the additional users (user 2, e.g.), using their respective sub-carriers.

The embodiments depicted by FIG. 4, employ some illustrative sub-components of the components depicted in FIG. 3. For example, depending on the user referred to, null generator 310 may be viewed as comprising frequency nulling component 410, 411 or 412. Symbol inserter 320 may be viewed as comprising block repeater 420, 421 or 422 and adder 430, 431 or 432. And IFDMA modulator 330 may be viewed as comprising block repeater 440, 441 or 442, frequency shifter 460, 461 or 462, and frequency shifter 451 or 452 (only for the case of user 2 or 3, respectively).

In the example depicted by FIG. 4, user 1 has a code of (64, 4, 0). This means that user 1 has 64 symbols per block, a repetition factor of 4 and no in-band modulation frequency shift. Frequency nulling component 410 embeds frequency domain nulls into the user 1 data symbol sequence to produce a null-embedded data symbol sequence. Block repeater 420 repeats (i.e., duplicates 8 times) the control (in this case pilot) symbol sequence to produce a repeated pilot symbol sequence. Adder 430 adds, symbol-by-symbol, the null-embedded data symbol sequence and the repeated control symbol sequence to produce a combined symbol sequence. Block repeater 440 repeats (i.e., duplicates 4 times, according to the IFDMA code) the combined symbol sequence to produce a repeated combined symbol sequence.

In a similar fashion, user 3 has a code of (128, 2, 1). This means that user 3 has 128 symbols per block, a repetition factor of 2 and an in-band modulation frequency shift of 1. Frequency nulling component 412 embeds frequency domain nulls into the user 3 data symbol sequence to produce a null-embedded data symbol sequence. Block repeater 422 repeats (i.e., duplicates 8 times) the pilot symbol sequence to produce a repeated pilot symbol sequence. Adder 432 adds, symbol-by-symbol, the null-embedded data symbol sequence and the repeated control symbol sequence to produce a combined symbol sequence. Block repeater 442 repeats (i.e., duplicates 2 times, according to the IFDMA code) the combined symbol sequence to produce a repeated combined symbol sequence. Frequency shifter 452 performs an in-band modulation frequency shift equal to 1 (according to the IFDMA code) to the repeated combined symbol sequence.

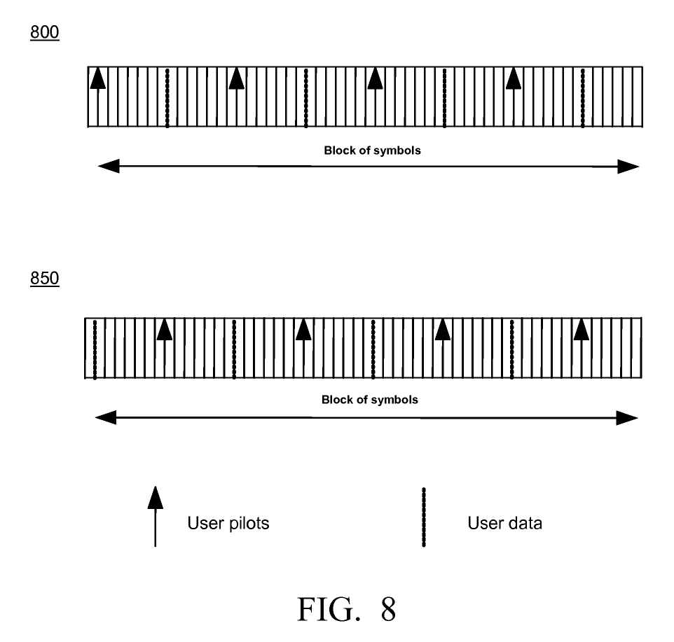

Lastly, in some embodiments, the transmitters may employ frequency hopping, in which control symbols are hopped on different sub-carriers in different blocks. This technique enables better channel estimation and/or less pilot overhead with a properly designed channel estimation algorithm. In the embodiments depicted in FIG. 4, frequency shifters 460-462 perform a frequency shift of some frequency hopping amount Z. Z should vary with time in some fashion; for example, Z may vary from block-to-block and/or according to some predefined hopping pattern. FIG. 8 is a block diagram illustration of an example of frequency hopping from one block to the next. In this example, the user pilots and user data are shifted in block 850 relative to their frequency domain positions in block 800.

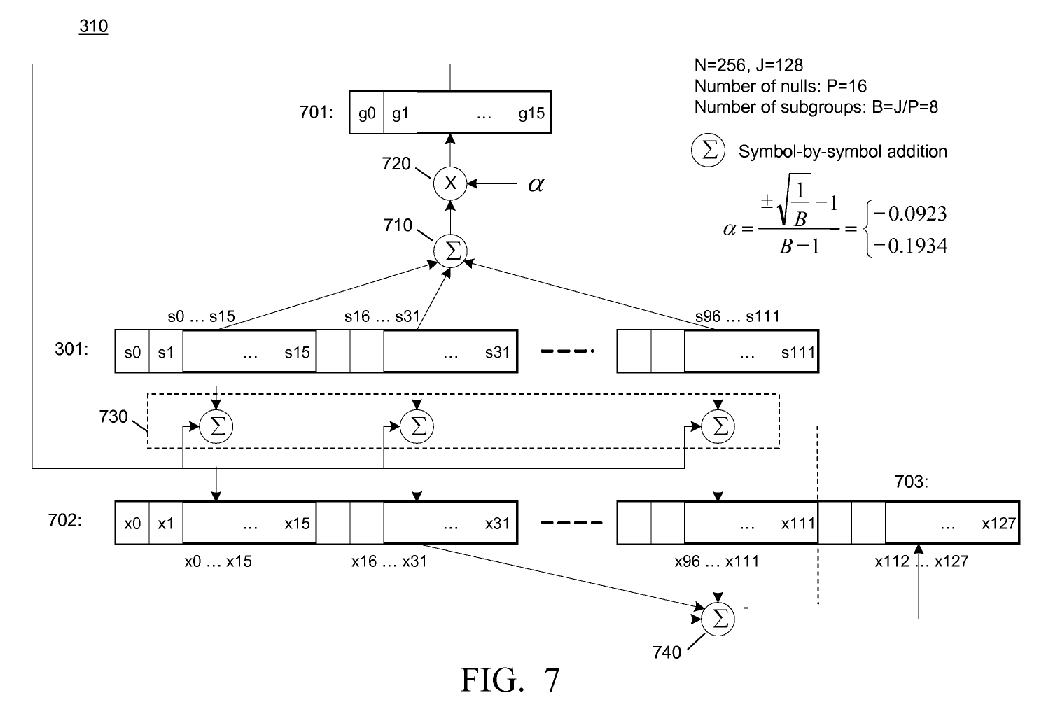

The embodiments depicted by FIG. 7 employ some sub-components of null generator 310 for embedding frequency domain nulls into a data symbol sequence. The depiction of these sub-components is intended to serve as an example of a manner in which one might design a null generator such as null generator 310. Beginning with data symbol sequence 301, adder 710 linearly adds together symbols having the same position in their respective subgroups of data symbol sequence 301. This generates a first group of symbols, which is scaled by normalizer 720 by a normalization factor α, as shown. The addition and scaling produce a group of padding symbols 701.

For the sake of providing an example, a number of numerical values are assumed in FIG. 7. The IFDMA symbol block size is 256, 128 symbols are transmitted with a repetition factor of 2, and there are 16 pilots inserted into a (128, 2, 0) sub-channel. Thus, there are 16 frequency nulls (P=16) and eight sub-blocks (B=8).

Adder 730 linearly adds to each symbol from data symbol sequence 301 a symbol having the same position in the group of padding symbols 701 as that symbol has in its subgroup to produce summed symbol sequence 702. Adder 740 linearly adds together symbols having the same position in their respective subgroups of summed symbol sequence 702. This generates a second group of symbols 703. The output of null generator 310, the null-embedded data symbol sequence, is the result of appending the second group of symbols 703 to the summed symbol sequence 702. For a more detailed analysis and explanation of the underlying concepts behind embedding frequency domain nulls, the reader is directed to a co-pending application, having Ser. No. 11/054,290, filed Feb. 9, 2005 and entitled “METHOD AND APPARATUS FOR TRANSMISSION AND RECEPTION OF DATA.”

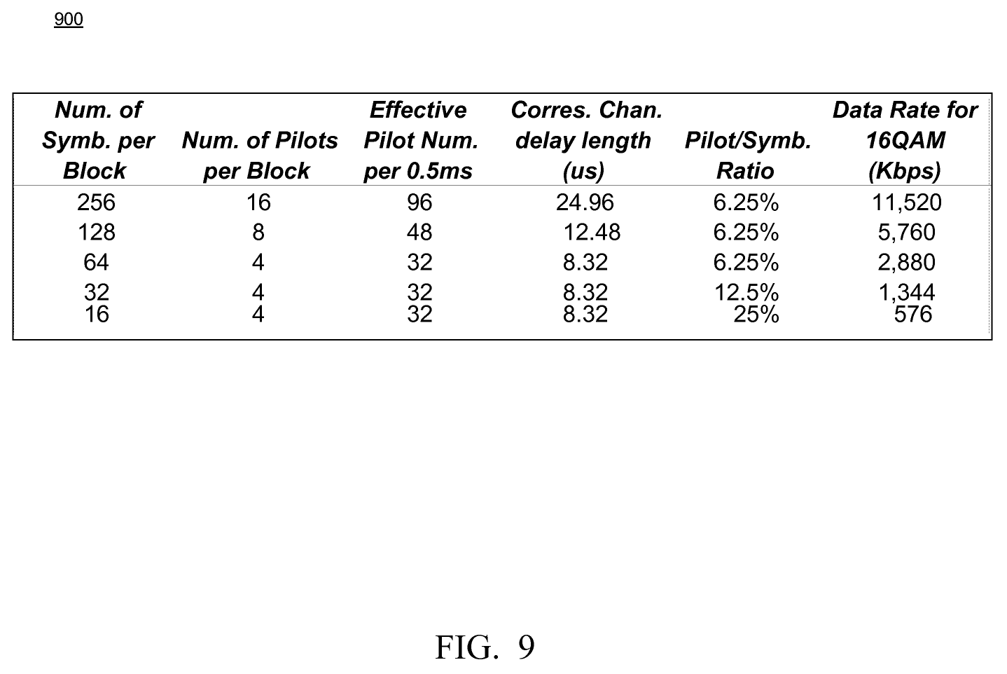

FIG. 9 is a table 900 conveying some numerical characteristics of various embodiments of the present invention. They apply to designs in which there are 6 IFDMA blocks/0.5 ms slot and 256 chips per IFDMA block. Since TDM pilot configurations are thought to exhibit 10%--20% pilot overhead (i.e., a pilot to symbol ratio), a benefit can be seen for embodiments of the present invention over TDM pilot configurations when the symbol number per block is large greater than or equal to 32, for example.

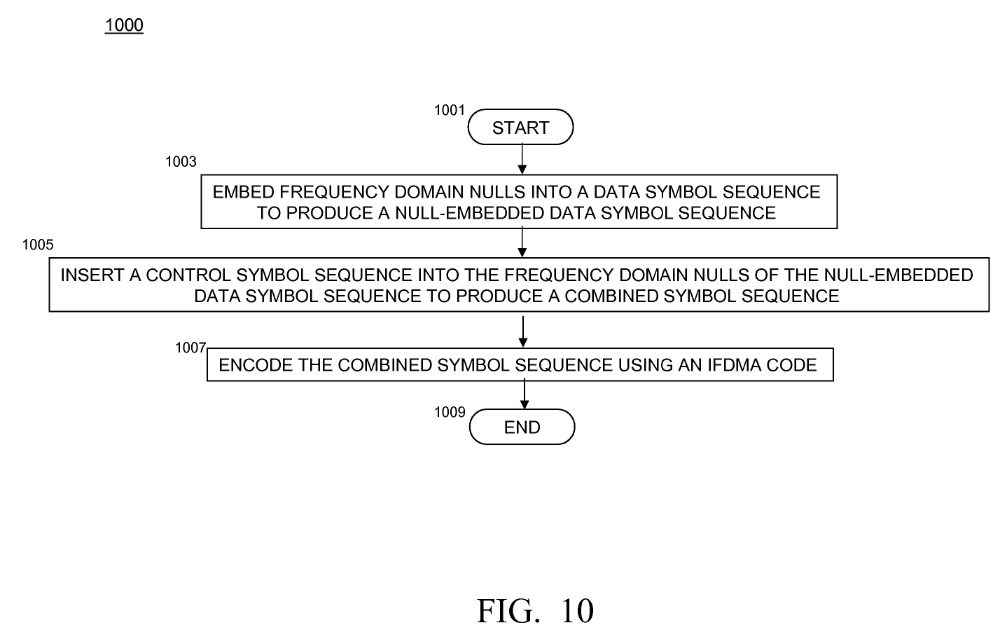

FIG. 10 is a logic flow diagram illustrating functionality performed in transmitting data in accordance with multiple embodiments of the present invention. Logic flow 1000 begins (1001) with the embedding (1003) of frequency domain nulls into a data symbol sequence to produce a null-embedded data symbol sequence. A control symbol sequence is then inserted (1005) into the frequency domain nulls of the null-embedded data symbol sequence to produce a combined symbol sequence. This combined symbol sequence is then encoded (1007) using an IFDMA code before logic flow 1000 ends (1009). Depending on the particular embodiment of the present invention, functionality not depicted in FIG. 10 may be additionally performed in order to effect the transmission of data.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language).

What is claimed is:

1. An apparatus comprising:
a null generator for embedding frequency domain nulls into a data symbol sequence to produce a null-embedded data symbol sequence;
a symbol inserter for inserting a control symbol sequence into the frequency domain nulls of the null-embedded data symbol sequence to produce a combined symbol sequence; and
a modulator for encoding the combined symbol sequence using IFDMA (interleaved frequency division multiple access)/DFT-S-OFDM (discrete fourier transform spread orthogonal frequency division multiplexing).

2. The apparatus of claim 1, wherein the apparatus resides in user equipment (UE).

3. The apparatus of claim 1, wherein the null generator comprises:
a first adder for linearly adding together symbols having the same position in their respective groups to generate a group of symbols, wherein the groups are subgroups of the data symbol sequence;
a normalizer for scaling each symbol of the group of symbols by a normalization factor to produce a group of padding symbols used to generate the null-embedded data symbol sequence;
a second adder for linearly adding to each symbol from the data symbol sequence a symbol having the same position in the group of padding symbols as that symbol has in its subgroup to produce a summed symbol sequence; and
a third adder for linearly adding together symbols having the same position in their respective subgroups of the summed symbol sequence to generate a second group of symbols, wherein the null-embedded data symbol sequence is the second group of symbols appended to the summed symbol sequence.

4. The apparatus of claim 1, wherein the symbol inserter comprises:
a block repeater for performing block repetition of the control symbol sequence to produce a repeated control symbol sequence; and
an adder for adding, symbol-by-symbol, the null-embedded data symbol sequence and the repeated control symbol sequence to produce the combined symbol sequence.

5. The apparatus of claim 1, wherein the modulator comprises:
a block repeater for performing, according to an IFDMA/DFT-S-OFDM code, a number of block repetitions of the combined symbol sequence to produce a repeated combined symbol sequence; and
a frequency shifter for performing, by a frequency shift amount, an in-band modulation frequency shift of the repeated combined symbol sequence, wherein the frequency shift amount is indicated by the IFDMA/DFT-S-OFDM code.

6. The apparatus of claim 1, wherein the modulator comprises:
a frequency shifter for performing a frequency shift of a frequency hopping amount.

7. A method comprising:
embedding frequency domain nulls into a data symbol sequence to produce a null-embedded data symbol sequence;
inserting a control symbol sequence into the frequency domain nulls of the null-embedded data symbol sequence to produce a combined symbol sequence; and
encoding the combined symbol sequence using IFDMA (interleaved frequency division multiple access)/DFT-S-OFDM (discrete fourier transform spread orthogonal frequency division multiplexing).

8. The method of claim 7, wherein inserting the control symbol sequence comprises inserting a pilot symbol sequence.

9. The method of claim 7, wherein embedding frequency domain nulls into a data symbol sequence comprises:
linearly adding together symbols having the same position in their respective groups to generate a group of symbols, wherein the groups are subgroups of the data symbol sequence;
scaling each symbol of the group of symbols by a normalization factor to produce a group of padding symbols used to generate the null-embedded data symbol sequence;
linearly adding to each symbol from the data symbol sequence a symbol having the same position in the group of padding symbols as that symbol has in its subgroup to produce a summed symbol sequence; and
linearly adding together symbols having the same position in their respective subgroups of the summed symbol sequence to generate a second group of symbols, wherein the null-embedded data symbol sequence is the second group of symbols appended to the summed symbol sequence.

10. The method of claim 7, wherein inserting the control symbol sequence into the frequency domain nulls of the null-embedded data symbol sequence comprises:
performing block repetition of the control symbol sequence to produce a repeated control symbol sequence; and
adding, symbol-by-symbol, the null-embedded data symbol sequence and the repeated control symbol sequence to produce the combined symbol sequence.

11. The method of claim 7, wherein encoding the combined symbol sequence using IFDMA/DFT-S-OFDM comprises:
performing, according to an IFDMA/DFT-S-OFDM code, a number of block repetitions of the combined symbol sequence to produce a repeated combined symbol sequence; and
performing, by a frequency shift amount, an in-band modulation frequency shift of the repeated combined symbol sequence, wherein the frequency shift amount is indicated by the IFDMA/DFT-S-OFDM code.

12. The method of claim 7, wherein embedding, inserting and encoding is performed for a plurality of users, each of whom has an associated data symbol sequence, an associated a control symbol sequence and an associated IFDMA/DFT-S-OFDM code.

13. The method of claim 7,
wherein encoding the combined symbol sequence comprises performing a frequency shift of a frequency hopping amount.

14. The method of claim 13, wherein the frequency hopping amount varies with time.

15. The method of claim 14, wherein the frequency hopping amount varies from block-to-block.

16. The method of claim 13, wherein the frequency hopping amount varies according to a predefined hopping pattern.
